(19) United States
(12) Patent Application Publication
(10) Pub. No.: US 2008/0249788 A1
(43) Pub. Date: Oct. 9, 2008

(54) METHOD FOR DEVELOPING AN OBJECTIVE OPINION

(76) Inventors: Stephen Heller, Monroe, NJ (US); Justin Heller, Hillsdale, NJ (US)

Correspondence Address: HOLLAND & KNIGHT LLP, 10 ST. JAMES AVENUE, 11th Floor, BOSTON, MA, 02116-3889, US

(21) Appl. No.: 11/696,897

(22) Filed: Apr. 5, 2007

(51) Int. Cl. G06Q 30/00

(52) U.S. Cl. 705/1

(57) ABSTRACT

Methods and apparatus, including computer program products, for deriving an objective opinion profile. A method includes receiving a request from an entity, such as a buyer or a seller, and retrieving data regarding that entity from trusted sources. The data regarding the entity from the trusted sources may include publicly available data, such as credit reports, financial reports, market data aggregators, electronic marketplaces, court filings, police records, and governmental records. The objective opinion profile can be built from the data retrieved from the trusted sources and displayed to the requesting entity.

### FIELD OF INVENTION

The present invention relates to socio-economic opinions and more specifically to a method for developing an objective opinion.

### BACKGROUND

The emergence of large communications networks, most notably the Internet, has dramatically increased the quantity and nature of electronic exchanges between entities (e.g., sellers or buyers). An electronic exchange is any exchange between two or more entities over an electronic network (e.g., not in person) such as a data communications network (e.g., LAN or the Internet), a voice communications network (e.g., POTS or PBX) or voice-and-data communications network (e.g., VOIP). Electronic exchanges may include electronic business transactions and electronic communications. Electronic business transactions may include the negotiation and sale of goods or services, including the solicitation of customers, and offer and acceptance. For example, in a consumer-to-consumer electronic marketplace, (e.g., eBay®, PayPal®, Yahoo®, Amazon®, Orbitz® and similar marketplaces found on the Internet) entities may transact for the sale and purchase of goods or services. An entity may be an electronic agent (e.g., a software agent), an individual or a company. An electronic agent may act on behalf of an individual, corporation, agency, organization, partnership, or other group. A person may act as an individual (e.g., on the person's own behalf) or as a representative (e.g., officer or agent) of a corporation, agency, organization, partnership, or other group.

In many electronic exchanges, an entity's (e.g., a seller) identity may remain anonymous to or unconfirmed by a second entity (e.g., a buyer). Anonymity poses several issues regarding trust and reliability in connection with electronic exchanges. An unconfirmed or anonymous entity selling goods or services on-line may easily disguise who they are or misrepresent their role in a marketplace. Individuals can misrepresent themselves as being a legally formed corporation, offering to provide goods and services, when they are not.

Unlike conventional purchasing, where buyers issue payment at the time the goods and services are provided, typically electronic marketplace transactions require buyers to prepay for the products and services prior to shipment. Unlike conventional credit/charge card prepayment purchases via a voice, data or voice-over-data communications network, the card company is unable to intercede on behalf of the buyer if the seller has misrepresented themselves or the goods or services they are selling. In an electronic marketplace, or e-commerce transaction, the buyer is far more at risk of being defrauded than they are with more traditional purchasing methods. Many electronic marketplace business models completely shift the risk from seller to buyer. The buyer is primarily reliant upon anecdotal information that the seller is a bona fide entity and is therefore far more at risk in an electronic transaction than the seller and has little to no legal protection against fraud perpetrated by a seller.

### SUMMARY

The present invention provides a method to form an opinion by unobtrusively utilizing multiple and various forms of legal and economic data in a real-time and automated manner.

In general, in one aspect, the invention features a computer-implemented method of deriving an objective opinion profile including receiving a request from an entity and retrieving data regarding that entity from trusted sources. The objective opinion profile is built from the data retrieved from the trusted sources and displayed to the entity.

In embodiments, the request from the entity may be a manual request. In other embodiments, the request from the entity may be an automatic request based on a predetermined event or time period.

In various embodiments, the data retrieved from trusted sources is predicative data. The predicative data may include financial scores, credit scores, bankruptcy proceedings, judgments, liens, lawsuits, subjected feedback, business complaints, criminal convictions and so forth.

In embodiments, the data from trusted sources may be publicly available data, including credit reports, financial reports, market data aggregators, electronic marketplaces, court filings, police records, governmental records and so forth.

In various embodiments, the entity may be sellers, buyers, individuals, groups of people, legal entities, and companies. Displaying the objective opinion profile to the entity may include publishing the objective opinion profile to a list.

In general, in another aspect, the invention features a computer-implemented method of deriving an objective opinion of a seller. The method may include receiving a request for an objective opinion of the seller from a buyer and retrieving data regarding the seller from trusted sources. The objective opinion profile of the seller is built from the data retrieved from the trusted sources and displayed to the buyer.

In embodiments, the method also includes notifying the seller of the request from the buyer. In further embodiments, the seller provides information to enable the objective opinion profile to be calculated. In embodiments, the information provided by the seller to enable the objective opinion profile to be calculated may include financial reporting agency identification numbers, tax identification numbers, social security numbers, entity names, entity addresses, local government identification numbers and so forth.

In various embodiments, the request from the buyer may be a manual request or an automatic request based on a predetermined event or time period.

In embodiments, the data retrieved from trusted sources may include financial scores, credit scores, bankruptcy proceedings, judgments, liens, lawsuits, subjected feedback, business complaints, criminal convictions and so forth.

In general, in another aspect, the invention features a computer program product, tangibly embodied in an information carrier, for deriving an objective opinion profile for an entity. The computer program product is operable to cause a data processing apparatus to retrieve data regarding the entity from trusted sources, build the objective opinion profile from the data retrieved from trusted sources, and display the objective opinion profile to the entity.

In embodiments, the request from the entity is a manual request. In other embodiments, the request from the entity is an automatic request based on a predetermined event or time period.

In various embodiments, the data retrieved from trusted sources may be predicative data. The predicative data may be financial scores, credit scores, bankruptcy proceedings, judgments, liens, lawsuits, subjected feedback, business complaints, criminal convictions and so forth.

In other various embodiments, the data from trusted sources may be publicly available data, such as credit reports, financial reports, market data aggregators, electronic marketplaces, court filings, police records, governmental records and so forth.

In embodiments, the entity may be sellers, buyers, individuals, groups of people, legal entities, or companies. In certain embodiments, the computer program product is operable to also cause the data processing apparatus to receive a request from a second entity to derive an objective opinion profile of the first entity and display the objective opinion to the second entity.

The invention can be implemented to realize one or more of the following advantages. For example, embodiments of the present invention are advances to subjective reputation feedback mechanisms that are currently prevalent because it is non-emotional and therefore reduces bias, error and inaccuracies inherent in those approaches. Furthermore the embodiments of the present invention are advances to time and event based monitoring mechanisms that are currently prevalent because it eliminates the need to monitor transaction-by-transaction performance that can fail at any of multiple points being monitored and result in reputations being characterized solely by electronic commerce behavior. By unobtrusively utilizing multiple and various forms of legal and economic behavior, a better sampling of data is collected and is consistent among all forms of entities regardless of the volume of electronic commerce transactions. A potential transaction partner can then look at this opinion risk profile and formulate an informed decision on whether they wish to accept the scored risk regarding that entity's ability to satisfy obligations.

Opinions can be formed independent of individual transactions. The rating logic and the values are uniform and applicable to all entities (e.g., individual, corporation, agency, organization, partnership, etc.), and eliminate the use of the buyer/seller feedback to establish credibility. These entities can be individuals, legally formed corporations or organizations as well as municipalities. The values used in the quantitative model are socially and financially accepted principles and are non-judgmental or subjective. The factors are tangible and measurable rather than perceived and provide an opinion regarding the risk that an entity (e.g., a seller or buyer) will satisfy the terms of an obligation.

### BRIEF DESCRIPTION OF THE DRAWINGS

FIG. 1 is a diagram of an automated objective opinion derivation system.

FIG. 2 is a flow diagram of a manual event based automated objective opinion derivation system.

FIG. 3 is a flow diagram of an automated event based automated objective opinion derivation system.

FIG. 4 is a table of various exemplary data elements.

FIG. 5 is a table of an exemplary rating scale.

Like reference numbers and designations in the various drawings indicate like elements.

### DETAILED DESCRIPTION

An embodiment of the present invention addresses the problem of using reputation to establish trust between two or more entities in the entities' ability to satisfy an electronic commerce transition (such as an auction) without the drawbacks of subjective or time sensitive feedback systems. The present invention generates an objective opinion about an entity's ability to satisfy its obligations by utilizing existing risk predicative and publicly filed data about the entity, such as that entity's ability to meet other financial or consumer obligations as well as it current legal standing in the marketplace and society at large. Financial risk and legal factors may be unobtrusively gathered by the embodiments of the present invention without bias, error, and time constraints endemic in current subjective feedback reputation satisfaction systems and in current systems that measure behavior at well-defined points in the commerce transaction.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

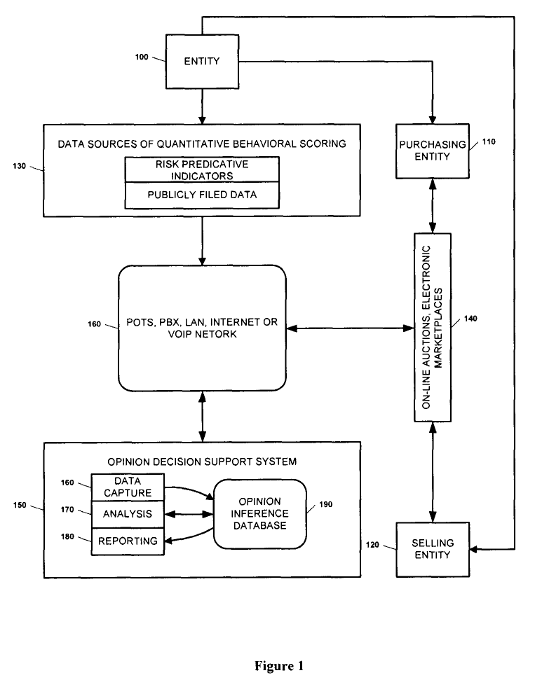

Embodiments of the present invention work by interacting with automated systems to obtain, store, and report financial risk, financial performance, ethical and legal factors on participant performance and behavioral information. Risk predicative and publicly filed data systems act as a trusted intermediary. FIG. 1 is a block diagram of an exemplary automated objective opinion derivation system 10 that provides an entity 100 with its own opinion profile. The entity 100 may be a seller 120 or a buyer 110. For example, a seller 120 will have financial risk and publicly disclosed profiles of legal events, such as, for example, credit reports and criminal files. These financial risk and publicly disclosed profiles are stored within trusted data sources 130 storing quantitative behavioral factors, such as, for example, credit reporting companies/agencies or governmental entities. The seller 120 interacts with an on-line auction or electronic commerce marketplace 140 over a data network 160, for example voice or data-and-voice communication networks. The opinion decision support system 150 will capture data 160, analyze the data 170, store the data in an opinion inference database 190 and report 180 upon the seller's 120 ability to satisfy an auction or electronic commerce obligation based on the analysis of the data 170, with quantitative risk and behavioral factors provided by the trusted data sources 130 and the electronic commerce marketplace 140.

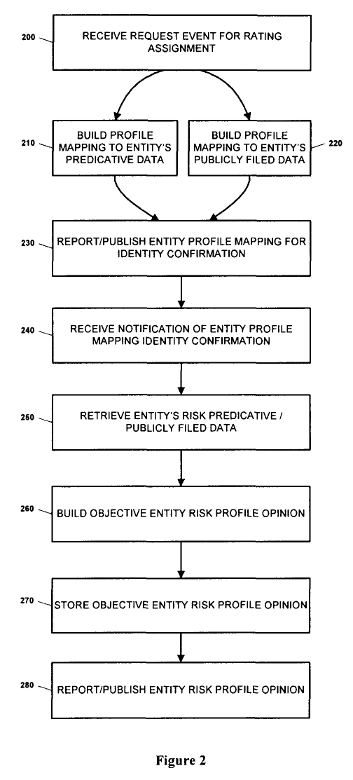

FIG. 2 is a flow diagram illustrating an exemplary manual event based automated objective opinion derivation system 20, for example, a buyer 110 seeking the opinion profile of a seller 120. The execution of the analysis of the data 170 resulting in the derivation of the stored opinion in the opinion inference database 190 may be performed upon request by the buyer 110 for the seller 120. The seller's 120 opinion profile is built through a mapping of the seller's 120 predicative 210 and publicly filed 220 data with the trusted data sources 130. For example, the seller 120 may provide information such as their name, legal address, company identifiers, federal tax identification, electronic commerce account names, email address, legal address history, employment history and other verifiable identification factors. The mapping of the seller's 120 predicative data 210 and publicly filed data 220 derive a target profile which is reported and published for identity confirmation 230 by seller 120. Upon receipt that the identity profile mapping 210, 220 is confirmed 240, the seller's 120 risk predicative and publicly file data is retrieved 250 from trusted data sources 130. The exemplary manual event based automated objective opinion derivation system 20 builds an objective opinion risk profile 260 on the entity at least in part on the financial and credit risk predicative 210 and publicly filed 220 legal event data retrieved from the trusted data sources 130. Any combination of information that gives an indication that the seller 120 has various risk characteristics associated with it may be used to generate the profile. The risk profile system may store that risk profile opinion 270 and may report, publish or otherwise disclose the seller's 120 risk profile opinion 280. This information may be disclosed upon request to the seller 120, from the buyer 10, or may simply be available in a list or history of risk opinion scoring for entity-to-entity electronic commerce participants.

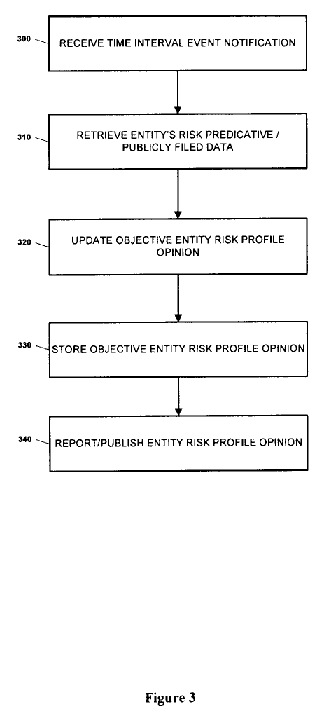

FIG. 3 is a flow diagram illustrating an automated event based automated objective opinion derivation system 30. For example, the execution of the analysis of the data 170 resulting in the derivation of the stored opinion in the opinion inference database 190 may be performed upon a scheduled or time based event interval 300 independent of a request from the buyer 110. The seller's 120 opinion profile will be built or updated through the existing mapping of the seller's 120 predicative data 210 and publicly filed data 220 with trusted data sources as derived from the trusted data sources 130. The automated event based automated objective opinion derivation system 30 builds an objective opinion risk profile 260 on the seller 120 at least in part on the financial and credit risk predicative data 210 and publicly filed legal event data 220 retrieved upon receiving a time interval event notification 300 from the trusted data sources 130. The automated event based automated objective opinion derivation system 30 then retrieves the seller's 120 data 310 and updates an existing objective opinion risk profile 320 on seller 120 at least in part on the financial and credit risk predicative data 210 and publicly file legal event data 220 retrieved upon event execution from the trusted data sources 130. Any combination of information, that gives an indication that the seller 120 has various risk characteristics associated with it, may be used to generate the profile. The automated event based automated objective opinion derivation system 30 may store that risk profile opinion 330 and may report, publish or otherwise disclose the seller's 120 risk profile opinion 340. This information may be disclosed upon request by the seller 120, the buyer 110, or may simply be available in a list or history of risk opinion scoring for entity-to-entity electronic commerce participants.

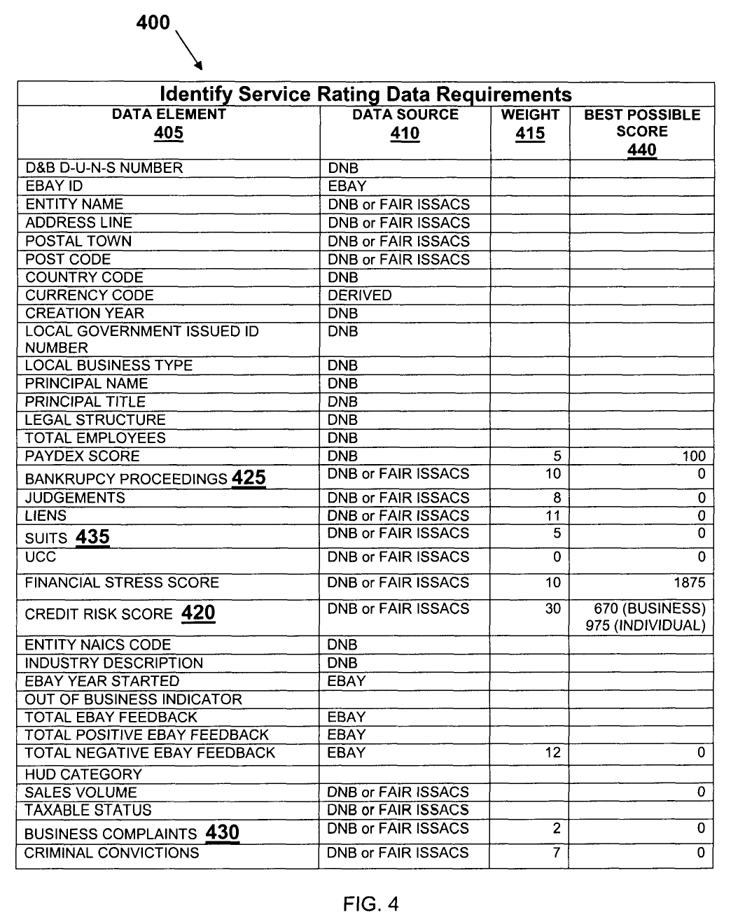

FIG. 4 is an exemplary table 400 of various data elements 405 that the manual event based automated objective opinion derivation system 20 and the automated event based automated objective opinion derivation system 30 may utilize in determining an objective opinion, as well as potential data sources 410. In building the seller's 120 opinion profile through the mapping of the data elements 405, the various data elements 405 may be given different weight 415 when calculating the overall rating. For example, credit score reports 420 and bankruptcy proceedings 425 may be given greater weight than business complaints 430 and lawsuits 435 because business complaints 430 and lawsuits 435 may tend to be more subjective. Each of the various data elements 405 may also be assigned a best possible score 440 which may be used in calculating the objective opinion. In one embodiment, the objective opinion may be derived using the following formula:
1. PAYDEX SCORE DIVIDED BY BEST POSSIBLE PAYDEX SCORE MULTIPLIED BY WEIGHT RANKING;
2. WEIGHT RANKING SUBTRACTED BY NUMBER OF BANKRUPTCY PROCEEDINGS DIVIDED BY BEST POSSIBLE BANKRUPTCY SCORE;
3. WEIGHT RANKING SUBTRACTED BY NUMBER OF JUDGMENTS DIVIDED BY BEST POSSIBLE JUDGMENTS SCORE
4. WEIGHT RANKING SUBTRACTED BY NUMBER OF LIENS DIVIDED BY BEST POSSIBLE LIENS SCORE;
5. WEIGHT RANKING SUBTRACTED BY NUMBER OF SUITS DIVIDED BY BEST POSSIBLE SUITS SCORE;
6. WEIGHT RANKING SUBTRACTED BY UCC OF SUITS DIVIDED BY BEST POSSIBLE UCC SCORE;
7. FINANCIAL STRESS SCORE DIVIDED BY BEST POSSIBLE FINANCIAL STRESS SCORE MULTIPLIED BY WEIGHT RANKING;
8. CREDIT SCORE DIVIDED BY BEST POSSIBLE CREDIT SCORE MULTIPLIED BY WEIGHT RANKING;
9. TOTAL NEGATIVE EBAY FEEDBACK TRANSACTIONS DIVIDED BY TOTAL EBAY FEEDBACK TRANSACTIONS (BEST POSSIBLE SCORE) MULTIPLIED BY WEIGHT RANKING;
10. WEIGHT RANKING SUBTRACTED BY BUSINESS COMPLAINTS DIVIDED BY BEST POSSIBLE BUSINESS COMPLAINTS SCORE;
11. WEIGHT RANKING SUBTRACTED BY CRIMINAL COMPLAINTS DIVIDED BY BEST POSSIBLE CRIMINAL COMPLAINTS SCORE

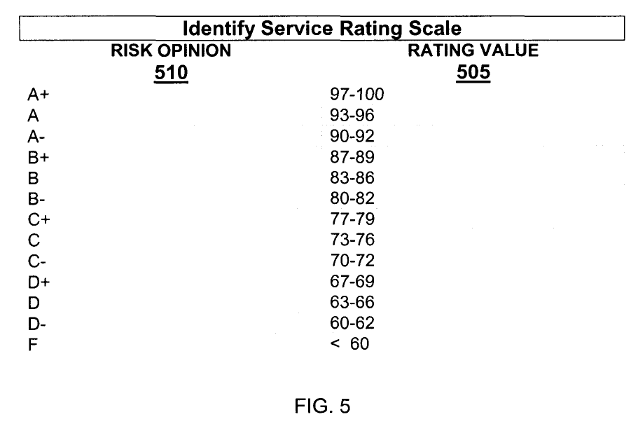

The objective opinion is generated by the sum of these derived scores (e.g.; 1+2+3+4+5+6+7+8+9+10+11). Referring to FIG. 5, a numeric value of the objective opinion derived 505 may be translated into an alpha rating equivalent 510.

The invention can be implemented in digital electronic circuitry, or in computer hardware, firmware, software, or in combinations of them. The invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

It is to be understood that the foregoing description is intended to illustrate and not to limit the scope of the invention, which is defined by the scope of the appended claims. Other embodiments are within the scope of the following claims. For example, while the entities have been described as a seller and a buyer, the entities could be any person, group of people or legal entity (e.g., company, corporation, municipality) that may conduct electronic business.

Also, while specific data elements 405 have been described, these data elements 405 are neither all inclusive or exclusive. Other data elements may be used and the data elements 405 described need not necessarily be used.

What is claimed is:

1. A computer-implemented method of deriving an objective opinion profile comprising:
receiving a request from an entity;
retrieving data regarding the entity from trusted sources;
building the objective opinion profile from the data retrieved from the trusted sources; and
displaying the objective opinion profile to the entity.

2. The computer-implemented method of claim 1 wherein the request from the entity is a manual request.

3. The computer-implemented method of claim 1 wherein the request from the entity is an automatic request based on a predetermined event or time period.

4. The computer-implemented method of claim 1 wherein the data retrieved from trusted sources comprises predicative data.

5. The computer-implemented method of claim 4 wherein the predicative data is selected from the group consisting of financial scores, credit scores, bankruptcy proceedings, judgments, liens, lawsuits, subjected feedback, business complaints and criminal convictions.

6. The computer-implemented method of claim 1 wherein the data from trusted sources comprises publicly available data.

7. The computer-implemented method of claim 6 wherein the publicly available data is selected from the group consisting of credit reports, financial reports, market data aggregators, electronic marketplaces, court filings, police records, and governmental records.

8. The computer-implemented method of claim 1 wherein the entity is selected from the group consisting of sellers, buyers, individuals, groups of people, legal entities, and companies.

9. The computer-implemented method of claim 1 wherein displaying the objective opinion profile to the entity comprises publishing the objective opinion profile to a list.

10. A computer-implemented method of deriving an objective opinion of a seller comprising:
receiving a request from a buyer;
retrieving data regarding the seller from trusted sources;
building the objective opinion profile of the seller from the data retrieved from the trusted sources; and
displaying the objective opinion profile to the buyer.

11. The computer-implemented method of claim 11 further comprising notifying the seller of the request from the buyer.

12. The computer-implemented method of claim 11 further comprising the seller providing information to enable the objective opinion profile to be calculated.

13. The computer-implemented method of claim 12 wherein the information provided by the seller to enable the objective opinion profile to be calculated is selected from the group consisting of financial reporting agency identification numbers, tax identification numbers, social security numbers, entity names, entity addresses and local government identification numbers.

14. The computer-implemented method of claim 10 wherein the request from the buyer is a manual request.

15. The computer-implemented method of claim 10 wherein the request from the buyer is an automatic request based on a predetermined event or time period.

16. The computer-implemented method of claim 10 wherein the data retrieved from trusted sources is selected from the group consisting of financial scores, credit scores, bankruptcy proceedings, judgments, liens, lawsuits, subjected feedback, business complaints and criminal convictions.

17. The computer-implemented method of claim 10 wherein the data from trusted sources comprises publicly available data.

18. The computer-implemented method of claim 17 wherein the publicly available data is selected from the group consisting of credit reports, financial reports, market data aggregators, electronic marketplaces, court filings, police records, and governmental records.

19. The computer-implemented method of claim 10 wherein displaying the objective opinion profile to the buyer comprises publishing the objective opinion profile to a list.

20. A computer program product, tangibly embodied in an information carrier, for deriving an objective opinion profile for an entity, the computer program product being operable to cause a data processing apparatus to:
retrieve data regarding the entity from trusted sources;
build the objective opinion profile from the data retrieved from trusted sources; and
display the objective opinion profile to the entity.

21. The computer program product of claim 20 wherein the request from the entity is a manual request.

22. The computer program product of claim 20 wherein the request from the entity is an automatic request based on a predetermined event or time period.

23. The computer program product of claim 20 wherein the data retrieved from trusted sources comprises predicative data.

24. The computer program product of claim 23 wherein the predicative data is selected from the group consisting of financial scores, credit scores, bankruptcy proceedings, judgments, liens, lawsuits, subjected feedback, business complaints and criminal convictions.

25. The computer program product of claim 20 wherein the data from trusted sources comprises publicly available data.

26. The computer program product of claim 25 wherein the publicly available data is selected from the group consisting of credit reports, financial reports, market data aggregators, electronic marketplaces, court filings, police records, and governmental records.

27. The computer program product of claim 20 wherein the entity is selected from the group consisting of sellers, buyers, individuals, groups of people, legal entities, and companies.

28. The computer program product of claim 20 wherein the computer program product being operable to further cause the data processing apparatus to:
receive a request from a second entity to derive an objective opinion profile of the first entity; and
display the objective opinion to the second entity.
